(19) United States
(12) Patent Application Publication
(10) Pub. No.: US 2005/0281188 A1
(43) Pub. Date: Dec. 22, 2005

(54) Transmitter and receiver for fast frequency hopping based on a cyclic frequency hopping pattern in an orthogonal frequency division multiplexing system

(75) Inventors: Yun-Ok Cho, Suwon-si (KR); Ju-Ho Lee, Suwon-si (KR); Joon-Young Cho, Suwon-si (KR); Peter Jung, Nordrhein-Westfalen (DE); Thomas Faber, Nordrhein-Westfalen (DE); Tobias Scholand, Nordrhein-Westfalen (DE); Guido Bruck, Nordrhein-Westfalen (DE)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/103,801

(22) Filed: Apr. 12, 2005

(30) Foreign Application Priority Data
Apr. 12, 2004 (KR) 2004-25137

(51) Int. Cl. H04J 11/00

(52) U.S. Cl. 370/208; 370/210

(57) ABSTRACT

A transmitter and receiver for fast frequency hopping based on a cyclic frequency hopping pattern in an orthogonal frequency division multiplexing system. The transmitter outputs a transmission signal vector having a plurality of samples. In the receiver, a first Fast Fourier Transform (FFT) processor transforms a first received signal vector into a second received signal vector of a frequency domain by using FFT. An equalizer multiplies the received signal vector by an inverse matrix of a channel matrix representing characteristics of a channel from the transmitter to the receiver. A modified IFFT processor transforms output of the equalizer by using IFFT, and multiplies IFFT outputs of a last stage of the modified IFFT processor by predetermined gains associated with the cyclic frequency hopping pattern of the transmitter. A second FFT processor transforms output of the modified IFFT processor by using FFT to output a recovered received signal vector.

### PRIORITY

This application claims priority to an application entitled “TRANSMITTER AND RECEIVER FOR FAST FREQUENCY HOPPING BASED ON A CYCLIC FREQUENCY HOPPING PATTERN IN AN ORTHOGONAL FREQUENCY DIVISION MULTIPLEXING SYSTEM”, filed in the Korean Intellectual Property Office on Apr. 12, 2004 and assigned Serial No. 2004-25137, the contents of which are incorporated herein by reference.

### BACKGROUND OF THE INVENTION

1. Field of the Invention

The present invention relates generally to an orthogonal frequency division multiplexing (OFDM) system, and more particularly to a transmitter and receiver for fast frequency hopping (FFH).

2. Description of the Related Art

An orthogonal frequency division multiplexing (OFDM) system transmits input data through a plurality of parallel carriers at a slow rate, such that the effect of inter-symbol interference (ISI) in a channel with frequency selective fading or multipath fading is reduced. When single-carrier transmission and multicarrier transmission are compared at the same data transmission rate, a symbol cycle for the multiple carriers' increases in proportion to the number of used carriers. The OFDM system has better spectral efficiency because spectra of subchannels overlap each other while maintaining orthogonality.

In the OFDM system, a transmission signal is modulated through Inverse Fast Fourier Transform (IFFT), and a received signal is demodulated through Fast Fourier Transform (FFT), such that a digital modulator and demodulator can be efficiently configured. This configuration is advantageous in that a receiver can be simply configured by a 1-tap equalizer, which requires a single complex multiplication step, because channel characteristics of each subchannel band are approximated in a regular or flat form within the subchannel band.

As one of multiple access schemes in an OFDM communication system, a frequency hopping (FH)-OFDM scheme performs FH in a subcarrier level. The FH scheme in the OFDM system transmits data while periodically changing a subcarrier or periodically performing the FH to prevent a user from continuously suffering deep fading according to frequency selective channel characteristics in the OFDM system for multiple users. In this case, an FH time unit is at least one symbol, and is conventionally one symbol duration. Because the FH scheme hops to a different subcarrier to transmit data for the next symbol time, when data is transmitted at a subcarrier suffering the deep fading for a symbol time, it can obtain the frequency diversity effect and average the interference between different cells while preventing one user from consecutively suffering the deep fading.

A base station supporting an FH-OFDM communication function dynamically allocates subcarriers to symbols according to a unique FH pattern. The FH pattern is formed by FH sequences that are orthogonal to each other, such that neighboring base stations can simultaneously use orthogonal subcarriers without interference between cells. A terminal identifies different FH patterns of the base stations by detecting the subcarriers, including pilot samples.

To sufficiently obtain the FH effect, the conventional OFDM system must perform FH through many symbol durations, requires many users, and must select an appropriate hopping pattern according to channels. Accordingly, the OFDM system using FH needs an optimum FH pattern for maximizing the frequency diversity effect and minimizing interference between cells.

### SUMMARY OF THE INVENTION

It is, therefore, an aspect of the present invention to provide a transmitter and receiver for fast frequency hopping (FFH) in an orthogonal frequency division multiplexing (OFDM) communication system.

It is another aspect of the present invention to provide a transmitter and receiver for fast frequency hopping (FFH) of a sample time unit in an orthogonal frequency division multiplexing (OFDM) communication system.

It is another aspect of the present invention to provide a cyclic frequency hopping pattern for performing fast frequency hopping (FFH) of a sample time unit in an orthogonal frequency division multiplexing (OFDM) communication system.

It is yet another aspect of the present invention to provide a transmitter and receiver for transmitting and receiving data using a cyclic frequency hopping pattern in an orthogonal frequency division multiplexing (OFDM) communication system.

The above and other aspects of the present invention can be achieved by a transmitter for performing fast frequency hopping (FFH) in an orthogonal frequency division multiplexing (OFDM) communication system using a plurality of subcarriers. The transmitter includes: a serial-to-parallel (S/P) converter for converting an input data stream into a data vector having a plurality of data elements associated with subchannels; a modified Inverse Fast Fourier Transform (IFFT) processor for transforming the data vector using IFFT, and outputting a transmission signal vector having a plurality of samples, which is formed by multiplying IFFT outputs of a last stage of the modified IFFT processor by predetermined gains according to a cyclic frequency hopping pattern, the cyclic frequency hopping pattern cyclically shifting subcarriers mapped to the subchannels in each sample time; and a parallel-to-serial (P/S) converter for converting the transmission signal vector in a serial fashion and outputting a transmission signal.

Additionally, a receiver is provided for recovering transmitted data according to a cyclic frequency hopping pattern in an orthogonal frequency division multiplexing (OFDM) communication system using a plurality of subcarriers. The receiver includes: a serial-to-parallel (S/P) converter for receiving, from a transmitter, a signal hopped to a frequency according to a cyclic frequency hopping pattern of a sample time unit, and converting the received signal into a first received signal vector having a plurality of data samples, the cyclic frequency hopping pattern cyclically shifting subcarriers mapped to subchannels in each sample time; a first Fast Fourier Transform (FFT) processor for transforming the first received signal vector into a second received signal vector of a frequency domain using FFT; an equalizer for multiplying the received signal vector by an inverse matrix of a channel matrix representing characteristics of a channel from the transmitter to the receiver; a modified Inverse Fast Fourier Transform (IFFT) processor for transforming output of the equalizer using IFFT, and multiplying IFFT outputs of a last stage of the modified IFFT processor by predetermined gains associated with the cyclic frequency hopping pattern of the transmitter; a second FFT processor for transforming output of the modified IFFT processor using FFT to output a recovered received signal vector; and a parallel-to-serial (P/S) converter for converting the recovered received signal vector in a serial fashion and outputting a data stream.

### BRIEF DESCRIPTION OF THE DRAWINGS

The above and other aspects and advantages of the present invention will be more clearly understood from the following detailed description taken in conjunction with the accompanying drawings, in which:

FIGS. 1A and 1E are conceptual diagrams illustrating vector signal models for multicarrier modulation in an orthogonal frequency division multiplexing (OFDM) system and a fast frequency hopping (FFH)/OFDM system;

FIG. 2 is a block diagram illustrating a transmitter of an FFH/OFDM communication system in accordance with an embodiment of the present invention;

FIG. 3 is a block diagram illustrating a receiver of the FFH/OFDM communication system in accordance with an embodiment of the present invention;

FIG. 4 is a block diagram illustrating a transmitter of the FFH/OFDM communication system in accordance with another embodiment of the present invention;

FIG. 5 is a conceptual diagram illustrating an Inverse Fast Fourier Transform (IFFT) algorithm of a transmitter of a basic OFDM system;

FIG. 6 illustrates a structure of a multicarrier modulator based on the IFFT algorithm of the transmitter of the basic OFDM system;

FIG. 7 illustrates a structure of a multicarrier modulator of the FFH/OFDM communication system in accordance with an embodiment of the present invention;

FIG. 8 illustrates a structure of a multicarrier modulator of an FFH/OFDM communication system based on a cyclic frequency hopping pattern in accordance with an embodiment of the present invention; and

FIG. 9 is a block diagram illustrating a receiver of the FFH/OFDM communication system based on the cyclic frequency hopping pattern in accordance with an embodiment of the present invention.

### DETAILED DESCRIPTION OF THE PREFERRED EMBODIMENTS

Preferred embodiments of the present invention will be described in detail herein below with reference to the accompanying drawings. In the following description, a detailed description of known functions and configurations incorporated herein will be omitted for conciseness. It is to be understood that the phraseology and terminology used herein are for the purpose of description and should not be regarded as limiting.

The present invention defines an appropriate frequency hopping pattern for implementing an orthogonal frequency division multiplexing (OFDM) system to which a fast frequency hopping (FFH) scheme is applied, and transmits and receives data according to the frequency hopping pattern. When M data elements are transmitted through M carriers, a total number of hopping patterns available for one hopping period is (M!)^{M}. Because the effect of the FFH scheme or hardware complexity in actual implementation differs according to a hopping pattern selected from all the available hopping patterns, it is very important for an efficient hopping pattern to be used. Accordingly, the following embodiments of the present invention provide the optimum frequency hopping pattern for maximizing the effect of the FFH scheme or minimizing the hardware complexity in actual implementation.

First, an operational principle of the OFDM communication system will be described.

M consecutive data elements are modulated into subcarriers f₁, f₂, . . . f_{M} whose frequencies have a predetermined interval. The M modulated signals form an OFDM signal. A difference between the subcarriers f₁, f₂, . . . f_{M} is set to the inverse of a predetermined symbol time Tₛ. Accordingly, different subcarriers are orthogonal to each other such that interference between the subcarriers can be avoided for one OFDM symbol time.

Because the OFDM signal is an analog signal, it is converted according to a digital scheme using Fast Fourier Transform (FFT). The OFDM signal must be sampled such that digital processing is performed. The OFDM signal is sampled at each sample time T_{d}, and an OFDM sample bₗ (where l=1, . . . , M) is output at each sample time T_{d}.

Because a channel of a single path does not use a cyclic prefix (CP) inserted into each symbol to prevent inter-symbol interference (ISI), the OFDM symbol time Tₛ becomes M times the OFDM sample time T_{d}. When the CP is used, the OFDM symbol time Tₛ becomes (M+CP) times the OFDM sample time T_{d}. The (M+CP) value is a sum of the number of M data samples and the number of CP samples. Consequently, the OFDM samples output during one OFDM symbol time Tₛ form one OFDM symbol. That is, the one OFDM symbol is formed by (M+CP) number of OFDM samples.

In the specification, an index of an OFDM symbol time is denoted by the subscript/superscript n, an index of a sample time is denoted by the subscript/superscript l, and an index of a subcarrier is denoted by the subscript/superscript m. Accordingly, t_{n,l} denotes the l-th sample time of the n-th symbol, and b⁽ⁿ⁾(t_{n,l}) denotes an OFDM sample signal in the time t_{n,l}.

Herein, the term “subchannel” indicates a conceptual channel for transmitting each of the M data elements used to generate an OFDM symbol. The term “subcarrier” indicates a transmission frequency mapped to the subchannel to be transmitted through a radio channel. The OFDM symbol time Tₛ is a time interval in which the M parallel data elements are input for multicarrier modulation. The OFDM sample time T_{d} is a time of sampling a multicarrier modulation signal.

In an FFH scheme in accordance with a preferred embodiment of the present invention, a time interval of hopping to a subcarrier for one subchannel is a single OFDM sample time or a multiple of the OFDM sample time. In the present invention, frequency hopping capable of being performed at each OFDM sample time will be described for the convenience of explanation. A mapping connection between a subcarrier and a subchannel is changed at each sample time during one symbol signal time. When each subchannel is mapped to a different subcarrier at each sample time in the FFH scheme, an OFDM sample signal vector is referred to as b_{H}. Here, the subscript H denotes FFH.

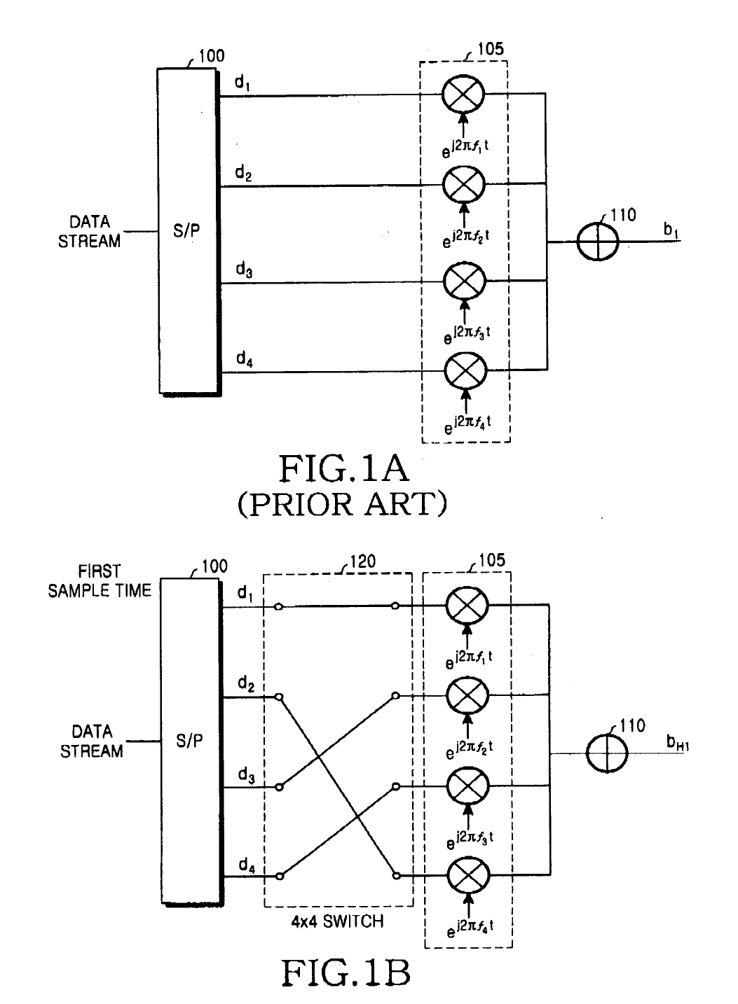

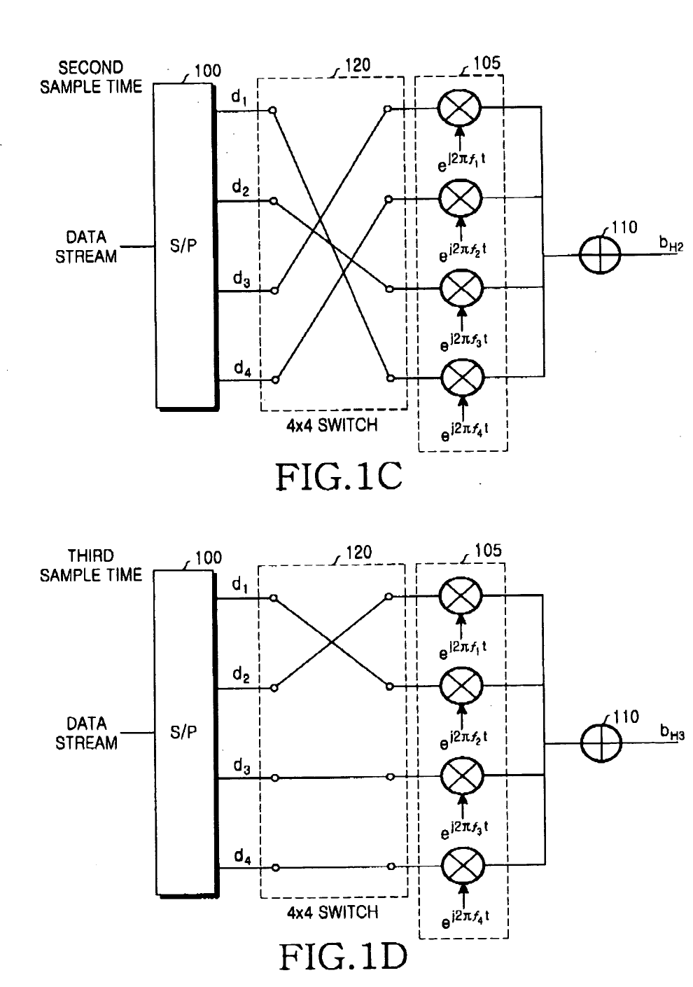

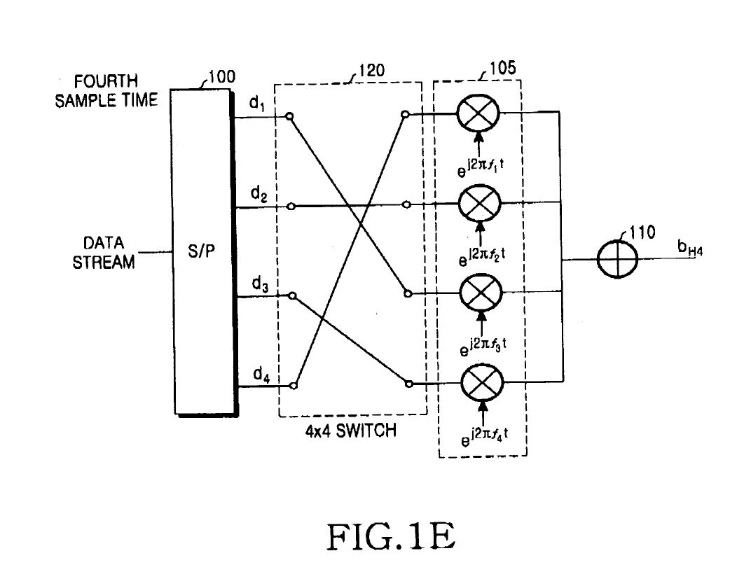

FIG. 1A is a schematic diagram illustrating an example in which a multicarrier modulator does not use frequency hopping where M=4. As illustrated in FIG. 1A, a serial-to-parallel (S/P) converter 100 converts a data stream into four data elements d₁, d₂, d₃, and d₄, which form a data vector d, and then outputs the four data elements to four subchannels. The four data elements d₁, d₂, d₃, and d₄ are input to corresponding multipliers of a multiplier unit 105, and are modulated into corresponding subcarriers. An adder 110 sums the subcarriers, and outputs a transmission signal vector bₗ. In this case, the four data elements are transmitted through fixed subcarriers during one symbol time.

FIGS. 1B to 1E are schematic diagrams illustrating examples of multicarrier modulators using frequency hopping, where M=4, in accordance with preferred embodiments of the present invention. As illustrated in FIGS. 1B to 1E, a 4*4 switch 120 is additionally arranged between the S/P converter 100 and the multiplier unit 105, and maps four inputs to four outputs according to a different FH pattern at each sample time.

FIG. 1B illustrates a switching process in the first sample time. The first, second, third, and fourth subchannels are mapped to the first, fourth, second, and third subcarriers, respectively.

FIG. 1C illustrates a switching process in the second sample time. The first, second, third, and fourth subchannels are mapped to the fourth, third, first, and second subcarriers, respectively.

FIG. 1D illustrates a switching process in the third sample time. The first, second, third, and fourth subchannels are mapped to the second, first, third, and fourth subcarriers, respectively.

FIG. 1E illustrates a switching process in the fourth sample time. The first, second, third, and fourth subchannels are mapped to the third, second, fourth, and first subcarriers, respectively.

The above-described sample times have different hopping patterns for subcarriers.

Subcarriers mapped to the first subchannel are [1 4 2 3] in order of time. Subcarriers mapped to the second subchannel are [4 3 1 2] in order of time. Subcarriers mapped to the third subchannel are [2 1 3 4] in order of time. Subcarriers mapped to the fourth subchannel are [3 2 4 1] in order of time. [1 4 2 3], [4 3 1 2], [2 1 3 4], or [3 2 4 1] is a hopping pattern for each subchannel.

Because a data signal d₁ of the first subchannel is fixedly modulated into the first subcarrier within one OFDM symbol, even when a channel state of the first subchannel is bad, as illustrated in FIG. 1A, an error occurs. In the multicarrier modulators of FIGS. 1B to 1E, the data signal d₁ of the first subchannel is transmitted through hopping to all subcarriers in order of [1 4 2 3] at the respective sample times, such that the probability of successfully recovering transmitted data in a receiving terminal is improved because of the frequency diversity effect, even when the channel state of the first subcarrier is bad. Similarly, data signals d₂, d₃, and d₄ of other subchannels hop to all subcarriers, i.e., all bands, within one OFDM symbol time. Accordingly, even when any one subcarrier suffers deep fading, the receiving terminal can recover original data.

To obtain the frequency diversity effect through frequency hopping in a symbol time unit, the conventional system requires many OFDM symbol durations, and a required time increases in proportion to an FFT size. However, the FFH scheme of the present invention, which is capable of performing frequency hopping at each OFDM sample time, can be added to the conventional frequency hopping of the symbol time unit in the OFDM system, and can improve the overall performance of the entire system owing to the frequency diversity effect.

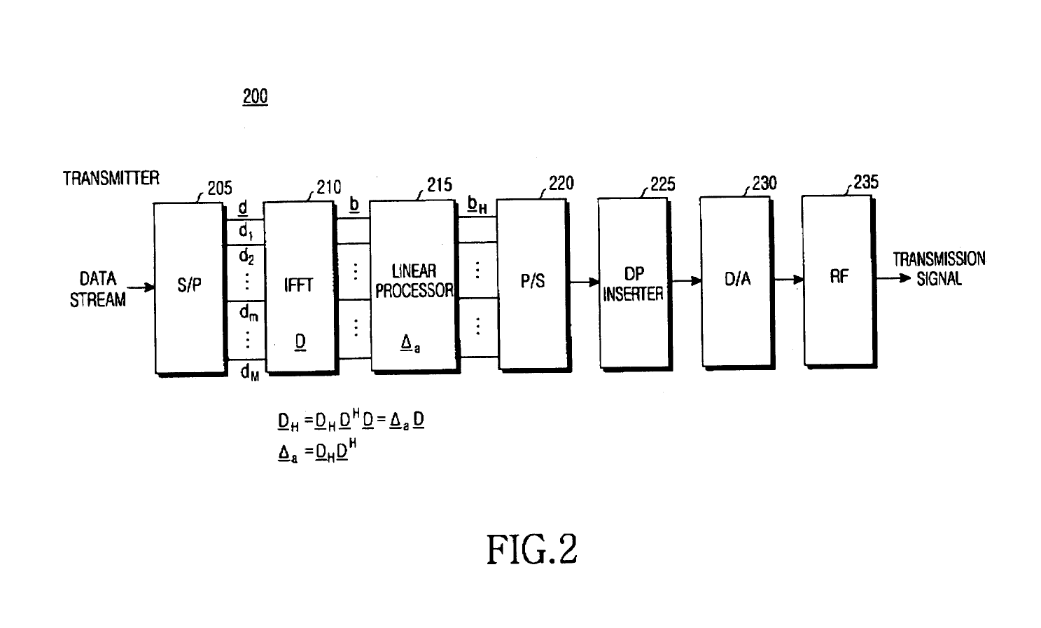

FIG. 2 is a block diagram illustrating a transmitter 200 of an FFH/OFDM communication system in accordance with an embodiment of the present invention. Referring to FIG. 2, an S/P converter 205 converts a data stream d input to the transmitter 200 into M data elements corresponding to M subchannels in a parallel fashion. The S/P converter 205 inputs the M data elements to an Inverse Fast Fourier Transform (IFFT) processor 210. The IFFT processor 210 transforms the input data elements into a time domain transmission signal b, and then transfers the time domain transmission signal b to a linear processor 215. The linear processor 215 transforms the transmission signal b into a time domain signal b_{H} based on frequency hopping according to a hopping pattern for each subchannel.

A P/S converter 220 converts the transmission signal vector b_{H} based on frequency hopping output from the linear processor 215 in a serial fashion, and then inputs the serial transmission signal to a CP inserter 225. The CP inserter 225 is selectively used. The CP inserter 225 inserts a CP corresponding to a repeat of the last part of the transmission signal output from the P/S converter 220. The transmission signal into which the CP has been inserted is output. A digital-to-analog (D/A) converter 230 converts an output signal of the CP inserter 225 into an analog signal. A radio frequency (RF) unit 235 converts the analog signal into an RF signal and then transmits the RF signal through a transmit antenna.

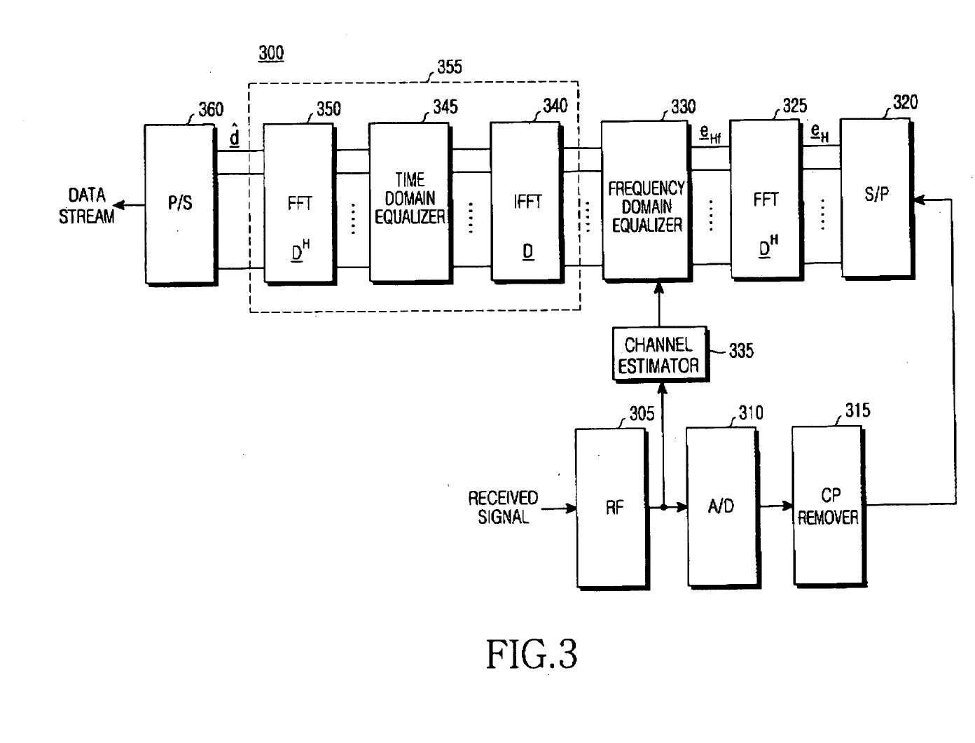

FIG. 3 is a block diagram illustrating a receiver 300 of the FFH/OFDM communication system in accordance with an embodiment of the present invention. Referring to FIG. 3, an RF unit 305 converts a multipath channel signal received through a receive antenna into a baseband signal. An analog-to-digital (A/D) converter 310 converts the baseband signal into a digital signal. A CP remover 315 removes a CP from the digital signal, and outputs a signal e_{H}. An S/P converter 320 converts the signal e_{H} in a parallel fashion, and inputs the converted signal to an FFT processor 325. The FFf processor 325 outputs a frequency domain signal e_{Hf} by multiplying the converted signal by an FFT matrix D^{H}.

The output signal e_{Hf} of the FFT processor 325 is input to a 1-tap equalizer 330 of the frequency domain (hereinafter, referred to as the frequency domain equalizer). A channel estimator 335 estimates element values of the channel matrix H_{f} of the frequency domain, i.e., channel gain values, from the signal received by the RF unit 305, and then outputs the estimated values to the frequency domain equalizer 330. The frequency domain equalizer 330 multiplies the frequency domain signal e_{Hf} by an equalization matrix M_{f} of the frequency domain.

Output of the frequency domain equalizer 330 is input to an IFFT processor 340. The IFFT processor 340 provides an equalizer 345 of the time domain (hereinafter, referred to as the time domain equalizer) with a result obtained by multiplying the output of the frequency domain equalizer 330 by an IFFT matrix D, i.e., by performing IFFT. The time domain equalizer 345 provides an FFT processor 350 with a result obtained by multiplying output of the IFFT processor 340 by an equalization matrix Mₜ of the time domain. The FFT processor 350 performs FFT by multiplying output of the time domain equalizer 345 by an FFT matrix D^{H}. The output of the FFT processor 350 is an estimated data vector \hat{d}, which output as an estimated data stream through a P/S converter 360.

The IFFT processor 340, the time domain equalizer 345, and the FFT processor 350 form a frequency hopping recovery unit 355 for recovering an original data stream by multiplying a time domain signal based on frequency hopping by a matrix M. The time domain equalizer 345 performs the inverse transformation of the transformation performed by the linear processor 215 illustrated in FIG. 2.

The frequency hopping recovery unit 355 configured by three components has been described. Alternatively, the frequency hopping recovery unit 355 may be configured by one entity capable of multiplying data by the matrix M in accordance with another embodiment of the present invention.

Now, mathematical signal modeling of the OFDM system will be described.

Herein, an index of an OFDM symbol time is denoted by the subscript/superscript n, an index of a sample time is denoted by the subscript/superscript l, and an index of a subcarrier is denoted by the subscript/superscript m. Accordingly, t_{n,l}, representing the l-th sample time of the n-th symbol is expressed by Equation (1). An OFDM sample signal b⁽ⁿ⁾(t_{n,l}) in the time t_{n,l} is expressed by Equation (2).

$$\begin{matrix}{t}_{n , l} = ( n - 1 ) {T}_{s} + ( l - 1 ) {T}_{d} & ( 1 ) \\ \begin{matrix}{b}^{( n )} ( {t}_{n , l} ) = \frac{1}{\sqrt{M}} {\sum }_{m = 1}^{M} {\underline{d}}_{m}^{( n )} \cdot exp \{ j2π \frac{{[ Φ ]}_{l , m}}{{T}_{s}} {t}_{n , l} \} \\ = \frac{1}{\sqrt{M}} {\sum }_{m = 1}^{M} {\underline{d}}_{m}^{( n )} \cdot exp \{ j2π {\frac{( l - 1 )}{M} [ Φ ]}_{l , m} \}\end{matrix} & ( 2 )\end{matrix}$$

In Equation (2), dₘ⁽ⁿ⁾ is input data transmitted through the m-th subcarrier in the n-th OFDM symbol, and the underline “_” denotes a vector formed by a plurality of data elements of the input data. [Ψ]_{l,m} is an element of the m-th column of the l-th row in a frequency hopping pattern matrix Ψ, and denotes an index of a subcarrier mapped to the m-th subchannel in the l-th sample time. The second right term of Equation (2) is obtained when Equation (1) is inserted into the first right term of Equation (2).

Assuming that M OFDM sample signals b₁,b₂, . . . , b_{M} of one OFDM symbol based on frequency hopping form an OFDM symbol vector b_{H}, M input data elements form a vector d, and a multicarrier modulation matrix using the hopping pattern matrix Ψ is D_{H}, the OFDM symbol vector b_{H} can defined by Equation (3).

$$\begin{matrix}{\underline{b}}_{H} = {\underline{D}}_{H} \underline{d} & ( 3 ) \\ \begin{matrix}{\underline{D}}_{H} = \frac{1}{\sqrt{M}} ( \begin{matrix}1 & 1 & ⋯ & 1 \\ exp \{ j2π \cdot \frac{1}{M} \cdot {[ Φ ]}_{2 , 1} \} & exp \{ j2π \cdot \frac{1}{M} \cdot {[ Φ ]}_{2 , 2} \} & ⋯ & exp \{ j2π \cdot \frac{1}{M} \cdot {[ Φ ]}_{2 , M} \} \\ ⋮ & ⋮ & ⋰ & ⋮ \\ exp \{ j2π \cdot \frac{M - 1}{M} \cdot {[ Φ ]}_{M , 1} \} & exp \{ j2π \cdot \frac{M - 1}{M} \cdot {[ Φ ]}_{M , 2} \} & ⋯ & exp \{ j2π \cdot \frac{M - 1}{M} \cdot {[ Φ ]}_{M , M} \}\end{matrix} ) \\ {[ {\underline{D}}_{H} ]}_{l , m} = \frac{1}{\sqrt{M}} exp \{ j2π \cdot \frac{l - 1}{M} \cdot {[ Φ ]}_{l , M} \} \\ Φ = [ \begin{matrix}{[ Φ ]}_{1 , 1} & {[ Φ ]}_{1 , 2} & ⋯ & {[ Φ ]}_{1 , M} \\ {[ Φ ]}_{2 , 1} & {[ Φ ]}_{2 , 2} & ⋯ & {[ Φ ]}_{2 , M} \\ ⋮ & ⋮ & ⋰ & ⋮ \\ {[ Φ ]}_{M , 1} & {[ Φ ]}_{M , 2} & ⋯ & {[ Φ ]}_{M , M}\end{matrix} ] , {[ Φ ]}_{l , M} = 0 , … , M - 1 ( l , m = 1 , … , M )\end{matrix} & ( 4 ) \\ \underline{d} = {( {d}_{1} , {d}_{2} , … , {d}_{M} )}^{T} & ( 5 )\end{matrix}$$

In the multicarrier modulation matrix D_{H}, as defined in Equation (4), each row is associated with sample times, and each column is associated with subchannels (i.e., data elements). In multicarrier modulation, phases differ according to values (l−1)[Ψ]_{l,m} of exponential functions in elements of the matrix D_{H}. In each of the exponential functions in the matrix elements of Equation (4), (l−1) denotes a phase variation value with respect to a sample time, and [Ψ]_{l,m} denotes a phase variation value with respect to a subcarrier. The multicarrier modulation matrix D_{H} is a result obtained by applying a frequency hopping pattern to the multicarrier modulation matrix D. Here, the term “basic OFDM system” identifies an OFDM system that does not perform frequency hopping. Multicarrier modulation of the basic OFDM system is implemented with an IFFT processor, and D denotes an IFFT matrix.

The frequency hopping pattern matrix in accordance with an embodiment of the present invention is expressed by Equation (6). At each sample time, the frequency hopping pattern maps each data element of the data vector to the next subcarrier adjacent to a subcarrier mapped to a previous data element. A first subcarrier mapped to the first data element can be arbitrarily set.
[Ψ]_{l,m}=mod {([f]ₗ+m−1), M}, m=1, . . . , M
[Ψ]_{l,1}=[f]ₗ, l=1, . . . , M (6)

Equation (6), ‘mod’ denotes modular operation. [f]ₗ denotes a subcarrier mapped to the first subchannel in the l-th sample time, and other subchannels in the l-th sample time are mapped to subsequent subcarriers in ascending order on the basis of [f]ₗ. Accordingly, if a mapping value [f]ₗ of the first subchannel in each sample time is only determined, subcarriers of the remaining subchannels are designated by modulo operation of Equation (6). Because this hopping pattern cyclically shifts subcarriers at each sample time, it is referred to as a cyclic frequency hopping pattern.

When the cyclic frequency hopping pattern is used, other components except the diagonal components of a transformation matrix Δₐ of the linear processor 215 in FIG. 2 always become zero as is shown in Equation (7).

$$\begin{matrix}{[ {Δ}_{a} ]}_{l , m} = {[ {\underline{D}}_{H} {\underline{D}}^{H} ]}_{l , m} \\ = \frac{1}{M} {\sum }_{μ = 1}^{M} exp \{ j2π \frac{l - 1}{M} \cdot {[ Φ ]}_{l , u} \} \\ exp \{ - j2π \frac{( m - 1 )}{M} \cdot ( μ - 1 ) \} \\ = \frac{1}{M} {\sum }_{μ = 1}^{M} exp \{ j \frac{2 π}{M} 〈 ( l - 1 ) \cdot {[ Φ ]}_{l , μ} - ( m - 1 ) \cdot ( μ - 1 ) 〉 \} \\ = \frac{1}{M} {\sum }_{μ = 1}^{M} exp \{ j \frac{2 π}{M} 〈 ( l - 1 ) \cdot mod \{ ( {[ f ]}_{l} + μ + 1 ) , M \} - \\ ( m - 1 ) \cdot ( μ - 1 ) 〉 \} \\ = \frac{1}{M} {\sum }_{μ = 1}^{M} exp \{ j \frac{2 π}{M} 〈 ( l - 1 ) \cdot mod \{ ( {[ f ]}_{l} + μ - 1 ) , M \} - \\ ( m - 1 ) \cdot mod \{ ( μ - 1 ) , M \} 〉 \} \\ = \{ \begin{matrix}exp \{ j2π \frac{{[ f ]}_{l}}{M} ( l - 1 ) \} , & if l = m \\ 0 , & otherwise\end{matrix}\end{matrix} \qquad ( 7 )$$

A computation of the linear processor 215 is the same as the form of independently multiplying signals output from the IFFT processor 210 by gain values. That is, according to characteristics of the diagonal matrix Δₐ, the multicarrier modulation based on the FFH scheme can be implemented by changing an output gain value of the IFFT processor 210.

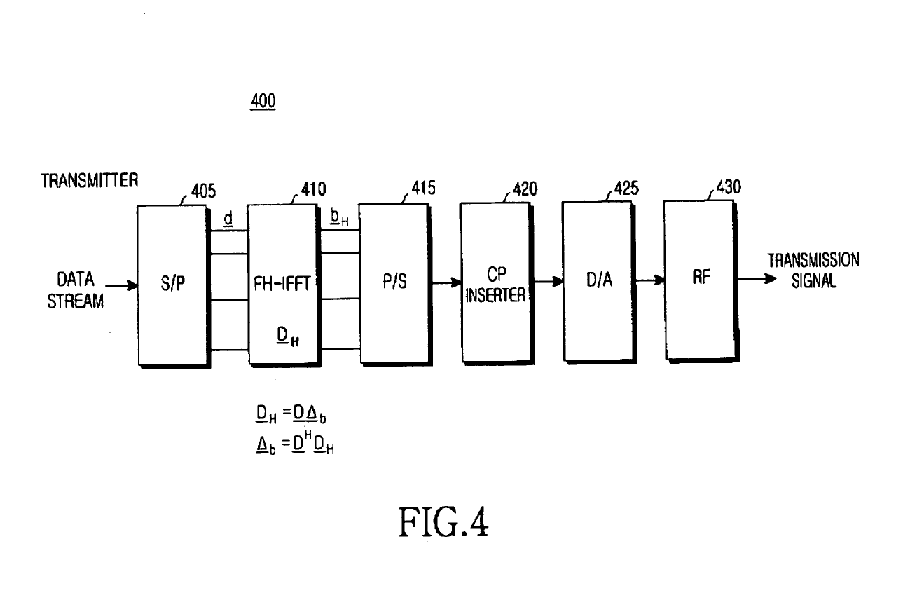

A structure of the transmitter using a modified IFFT processor in which a gain value of the last stage is changed according to a combination of the IFFT processor 210 and the linear processor 215 of FIG. 2, is illustrated in FIG. 4.

In FIG. 4, a transmitter 400 includes an S/P converter 405, a modified IFFT processor (hereinafter, referred to as the frequency hopping (FH)-IFFT processor) 410, a P/S converter 415, a CP inserter 420, a D/A converter 425, and an RF unit 430. Because operation of the other components, except for the FH-IFFT processor 410, has been described with reference to FIG. 2, another description is omitted here. The FH-IFFT processor 410 varies only gain values of output terminals of the conventional IFFT processor while performing the same function as that of the combination of the IFFT processor 210 and the linear processor 215 illustrated in FIG. 2.

Before a cyclic frequency hopping and multicarrier modulation operation is described with reference to the structure of the transmitter 400, a multicarrier modulation operation of the basic OFDM system, where M=4, will be described. The OFDM system for mapping the same subcarrier to each subchannel may be regarded as the FH/OFDM system based on the hopping pattern matrix as shown in Equation (8).
[Ψ]_{l,m}=m−1 for l=1, . . . , M (8)

A multicarrier modulation matrix is expressed in Equation (9).

$$\begin{matrix}\underline{D} = \frac{1}{\sqrt{4}} ( \begin{matrix}1 & 1 & 1 & 1 \\ 1 & exp \{ j2π \frac{1}{4} \cdot 1 \} & exp \{ j2π \frac{1}{4} \cdot 2 \} & exp \{ j2π \frac{1}{4} \cdot 3 \} \\ 1 & exp \{ j2π \frac{2}{4} \cdot 1 \} & exp \{ j2π \frac{2}{4} \cdot 2 \} & exp \{ j2π \frac{2}{4} \cdot 3 \} \\ 1 & exp \{ j2π \frac{3}{4} \cdot 1 \} & exp \{ j2π \frac{3}{4} \cdot 2 \} & exp \{ j2π \frac{3}{4} \cdot 3 \}\end{matrix} ) \\ = \frac{1}{2} ( \begin{matrix}1 & 1 & 1 & 1 \\ 1 & j & - 1 & - j \\ 1 & - 1 & 1 & - 1 \\ 1 & - j & - 1 & j\end{matrix} ) \\ = {\underline{D}}_{3} {\underline{D}}_{2} {\underline{D}}_{1} \\ = \frac{1}{2} ( \begin{matrix}1 & 0 & 0 & 0 \\ 0 & 0 & 1 & 0 \\ 0 & 1 & 0 & 0 \\ 0 & 0 & 0 & 1\end{matrix} ) ( \begin{matrix}1 & 1 & 0 & 0 \\ 1 & - 1 & 0 & 0 \\ 0 & 0 & 1 & j \\ 0 & 0 & 1 & - j\end{matrix} ) ( \begin{matrix}1 & 0 & 1 & 0 \\ 0 & 1 & 0 & 1 \\ 1 & 0 & - 1 & 0 \\ 0 & 1 & 0 & - 1\end{matrix} )\end{matrix} \qquad ( 9 )$$

The matrix of Equation (9) is an IFFT matrix, where M=4. According to an IFFT algorithm, the IFFT matrix is divided into matrices D₁, D₂, and D₃ of three stages. An output value of each matrix can be computed by a linear sum of two values in a previous stage.

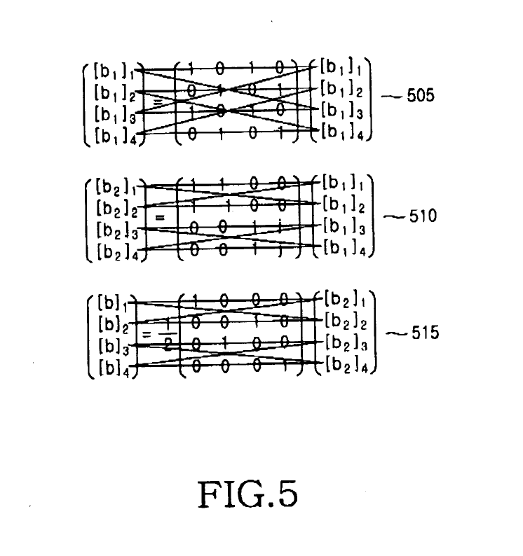

Referring to FIG. 5, after an input data vector d undergoes a computation with the matrix D₁ 505, b₁ is generated. After the vector b₁ undergoes a computation with the matrix D₂ 510, b₂ is generated. After the vector b₂ undergoes a computation with the matrix D₃ 515, b is finally generated as output of the basic IFFT processor 210.

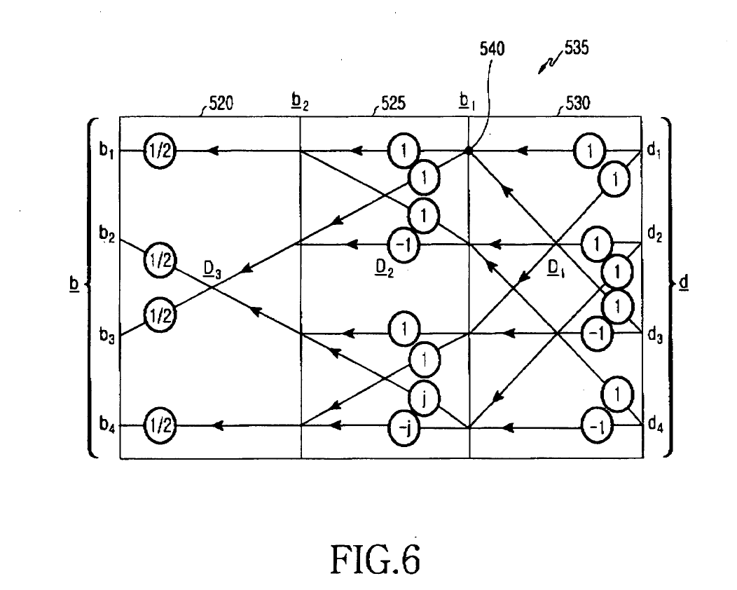

FIG. 6 is a conceptual diagram illustrating a multicarrier modulator 535 of the conventional OFDM system in which the matrices of the algorithm illustrated in FIG. 5 are implemented by hardware. In FIG. 6, three stages 530, 525, and 520 correspond to the stage-by-stage matrices D₁, D₂, and D₃ of Equation (9). The stages 530, 525, and 520 are expressed by a plurality of lines intersecting each other and circles arranged on the lines. The circles internally include ±1, ½, ±j, etc. Nodes serving as intersection points between the lines sum input line values. Values within the circles represent gains to be multiplied in corresponding lines. For example, a node 540 corresponding to [b₁]₁ receives line inputs of d₁ and d₃. Because the line gains of d₁ and d₃ all are 1, output of the node 540 is [b₁]₁=1×d₁+1×d₃.

An example of multicarrier modulation using the FFH scheme is expressed in Equation (10).

$${[ f ]}_{l} = {( 0 \; 3 \; 2 \; 1 )}^{T} , \\ Φ = ( \begin{matrix}0 & 1 & 2 & 3 \\ 3 & 0 & 1 & 2 \\ 2 & 3 & 0 & 1 \\ 1 & 2 & 3 & 0\end{matrix} ) -> {\underline{Δ}}_{a} = {\underline{D}}_{H} {\underline{D}}^{H} = diag ( 1 - j 1 - j ) \qquad ( 10 )$$

When an index sequence [f]₁ of subcarriers mapped to the first subchannel is [0, 3, 2, 1] in Equation (10), an index sequence [f]₂ of subcarriers mapped to the second subchannel according to a cyclic frequency hopping pattern becomes [1, 0, 3, 2], serving as a result obtained by incrementing each element value of the index sequence [f]₁ by one. Accordingly, the cyclic hopping pattern matrix Ψ is a diagonal matrix, and a linear matrix Δₐ computed from the hopping pattern matrix Ψ is a diagonal matrix. Using the linear matrix Δₐ as the diagonal matrix, a frequency hopping and multicarrier modulation matrix D_{H} is implemented step-by-step by hardware as illustrated in FIG. 6.

The matrix D_{H} is expressed step-by-step in Equation (11), similar to Equation (9).

$$\begin{matrix}{\underline{D}}_{H} = \frac{1}{\sqrt{4}} ( \begin{matrix}1 & 1 & 1 & 1 \\ exp \{ j2π \frac{1}{4} \cdot 3 \} & 1 & exp \{ j2π \frac{1}{4} \cdot 1 \} & exp \{ j2π \frac{1}{4} \cdot 2 \} \\ exp \{ j2π \frac{2}{4} \cdot 2 \} & exp \{ j2π \frac{2}{4} \cdot 3 \} & 1 & exp \{ j2π \frac{2}{4} \cdot 1 \} \\ exp \{ j2π \frac{3}{4} \cdot 1 \} & exp \{ j2π \frac{3}{4} \cdot 2 \} & exp \{ j2π \frac{3}{4} \cdot 3 \} & 1\end{matrix} ) \\ = {Δ}_{a} {\underline{D}}_{3} {\underline{D}}_{2} {\underline{D}}_{1} \\ = {\underline{D}}_{3 , H} {\underline{D}}_{2} \underline{D} \\ = \frac{1}{2} ( \begin{matrix}1 & 0 & 0 & 0 \\ 0 & 0 & - j & 0 \\ 0 & 1 & 0 & 0 \\ 0 & 0 & 0 & - j\end{matrix} ) ( \begin{matrix}1 & 1 & 0 & 0 \\ 1 & - 1 & 0 & 0 \\ 0 & 0 & 1 & j \\ 0 & 0 & 1 & - j\end{matrix} ) ( \begin{matrix}1 & 0 & 1 & 0 \\ 0 & 1 & 0 & 1 \\ 1 & 0 & - 1 & 0 \\ 0 & 1 & 0 & - 1\end{matrix} )\end{matrix} \qquad ( 11 )$$

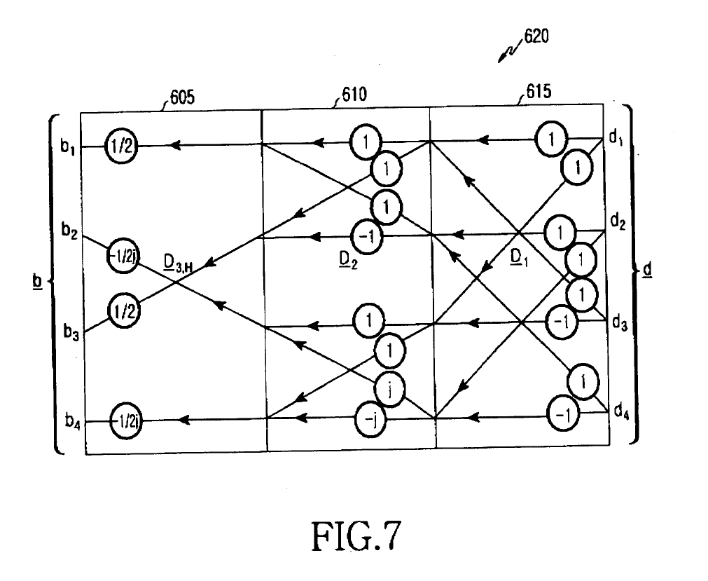

FIG. 7 is a conceptual diagram illustrating a multicarrier modulator 620 of the FFH/OFDM communication system in accordance with an embodiment of the present invention. The multicarrier modulator 620 corresponds to the FH-IFFT processor 410 of FIG. 4. Referring to FIG. 7, the frequency hopping and multicarrier modulator 620 includes three stages 605, 610, and 615. When the multicarrier modulator 620 of FIG. 7 is compared with the multicarrier modulator 535 of FIG. 6, the stages 615 and 610 of FIG. 7 are the same as the stages 530 and 525 of FIG. 6. Gain values of the last stage 605 are obtained by multiplying the gain values of the stage 520 by the values (1, −j, 1, −j) of diagonal components of the linear matrix Δₐ.

The operation and structure of the multicarrier modulator using the FFH scheme based on the cyclic frequency pattern when the above-mentioned example is extended, i.e., when the number of subchannels is M=2ⁿ, will be described herein below. An IFFT processor with M input taps and M output taps mapped to the M subchannels is configured by (n+1) stages mapped to (n+1) matrices.

The frequency hopping and multicarrier modulation matrix D_{H} for M (=2ⁿ) subchannels includes a matrix D_{n+1,H} of the last stage corresponding to the form of multiplying element values of an IFFT matrix Dₙ₊₁ by diagonal element values of the linear matrix Δₐ as shown in Equation (12).

$$For arbitrary M ( = {2}^{n} ) , \\ \begin{matrix}{\underline{D}}_{H} = {\underline{Δ}}_{a} \underline{D} \\ = {\underline{Δ}}_{a} {\prod }_{l = 1}^{n + 1} {\underline{D}}_{n + 2 - l} \\ = {\underline{D}}_{n + 1 , H} {\underline{D}}_{n} … {\underline{D}}_{2} {\underline{D}}_{1}\end{matrix} \\ ( {\underline{D}}_{n + 1 , H} = {\underline{Δ}}_{a} {\underline{D}}_{n + 1} , {\underline{Δ}}_{a} = {\underline{D}}_{H} {\underline{D}}^{H} ) \qquad ( 12 )$$

In Equation (12), the linear matrix Δₐ is designated according to the cyclic frequency hopping pattern Ψ, and the remaining stage matrices are shown in Equations (13) to (15).

$$\begin{matrix}\begin{matrix}{\underline{D}}_{1} = {\underline{C}}_{n , 0 \cdot {2}^{n}} \\ {\underline{D}}_{2} = ( \begin{matrix}{\underline{C}}_{n - 1 , ( 0 \cdot {2}^{n - 1} )} & {\underline{0}}_{{2}^{n - 1}} \\ {\underline{0}}_{{2}^{n - 1}} & {\underline{C}}_{n - 1 , ( 1 \cdot {2}^{n - 1} )}\end{matrix} ) , \\ {\underline{D}}_{3} = ( \begin{matrix}{\underline{C}}_{n - 2 , [ {2}^{n - 2} ( 0 + 0 \cdot 2 ) ]} & {\underline{0}}_{{2}^{n - 2}} & {\underline{0}}_{{2}^{n - 2}} & {\underline{0}}_{{2}^{n - 2}} \\ {\underline{0}}_{{2}^{n - 2}} & {\underline{C}}_{n - 2 , [ {2}^{n - 2} ( 0 + 1 \cdot 2 ) ]} & {\underline{0}}_{{2}^{n - 2}} & {\underline{0}}_{{2}^{n - 2}} \\ {\underline{0}}_{{2}^{n - 2}} & {\underline{0}}_{{2}^{n - 2}} & {\underline{C}}_{n - 2 , [ {2}^{n - 2} ( 1 + 0 \cdot 2 ) ]} & {\underline{0}}_{{2}^{n - 2}} \\ {\underline{0}}_{{2}^{n - 2}} & {\underline{0}}_{{2}^{n - 2}} & {\underline{0}}_{{2}^{n - 2}} & {\underline{C}}_{n - 2 , [ {2}^{n - 2} ( 1 + 1 \cdot 2 ) ]}\end{matrix} ) , \\ {\underline{ D}}_{k + 1} = ( \begin{matrix}{\underline{C}}_{n - k , [ {2}^{n - k} \cdot {\sum }_{l = 1}^{k} bin ( 0 , l ) \cdot {2}^{k - l} ]} & {\underline{0}}_{{2}^{n - k}} & ⋯ & {\underline{0}}_{{2}^{n - k}} \\ {\underline{0}}_{{2}^{n - k}} & {\underline{C}}_{n - k , [ {2}^{n - k} \cdot {\sum }_{l = 1}^{k} bin ( 0 , l ) \cdot {2}^{k - l} ]} & ⋯ & {\underline{0}}_{{2}^{n - k}} \\ ⋮ & ⋮ & ⋰ & ⋮ \\ {\underline{0}}_{{2}^{n - k}} & {\underline{0}}_{{2}^{n - k}} & ⋯ & {\underline{C}}_{n - k , [ {2}^{n - k} \cdot {\sum }_{l = 1}^{k} bin ( \{ {2}^{k} - 1 \} , l ) {2}^{k - l} ]}\end{matrix} ) , k = 0 … ( n - 1 ) , \\ {[ {\underline{D}}_{n + 1 , H} ]}_{ij} = \{ \begin{matrix}{\frac{1}{\sqrt{M}} [ {\underline{Δ}}_{a} ]}_{ii} , & for i , j = {\sum }_{l = 1}^{n} bin ( i , l ) \cdot {2}^{n - l} , & i , j = 0 … M - 1 ( = {2}^{n} - 1 ) \\ 0 , & else . & \end{matrix}\end{matrix} & ( 13 ) \\ {[ {\underline{C}}_{μ , r} ]}_{ij} = \{ \begin{matrix}1 & for i = 1 , j = 1 and j = {2}^{μ - 1} + 1 , \\ 1 & for i = 2 , j = 2 and j = {2}^{μ - 1} + 2 , \\ & ⋮ \\ 1 & for i = {2}^{μ - 1} , j = {2}^{μ - 1} and j = {2}^{μ} , \\ {\underline{W}}^{r} & for i = {2}^{μ - 1} + 1 , j = 1 , \\ - {\underline{W}}^{r} & for i = {2}^{μ - 1} + 1 , j = {2}^{μ - 1} + 1 , \\ {\underline{W}}^{r} & for i = {2}^{μ - 1} + 2 , j = 2 , \\ - {\underline{W}}^{r} & for i = {2}^{μ - 1} + 2 , j = {2}^{μ - 1} + 2 , \\ & ⋮ \\ {\underline{W}}^{r} & for i = {2}^{μ} , j = {2}^{μ - 1} , \\ - {\underline{W}}^{r} & for i = {2}^{μ} , j = {2}^{μ} , \\ 0 & else .\end{matrix} & ( 14 ) \\ \underline{W} = exp ( j \frac{2 π}{M} ) \\ μ = {\sum }_{l = 1}^{∞} bin ( μ , l ) \cdot {2}^{l - 1} , μ ∈ N , bin ( μ , l ) ∈ \{ 0 , 1 \} , … & ( 15 )\end{matrix}$$

In Equation (15), bin(μ,l) denotes the l-th digit of a binary value corresponding to a decimal value μ. For example, if μ=11, a binary value corresponding to the decimal value of 11 is “1011”. In the binary value, the first digit is bin(11,1)=1, the second and fourth digits are bin(11,2)=bin(11,4)=1, and the third digit is bin(11,3)=0.

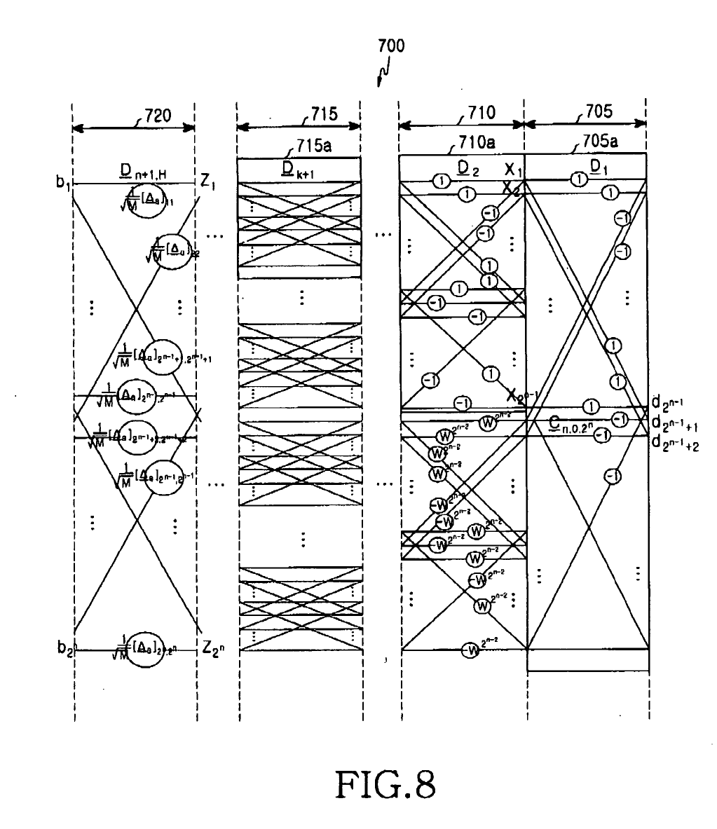

FIG. 8 illustrates a conceptual structure of a multicarrier modulator 700 for processing a cyclic frequency hopping pattern in accordance with an embodiment of the present invention. The multicarrier modulator 700 corresponds to details of the FH-IFFT processor 410 illustrated in FIG. 4.

Referring to FIG. 8, the multicarrier modulator 700 is configured by (n+1) stages 705, 710, 715, and 720. Reference numeral 705 denotes the first stage D₁, reference numeral 710 denotes the second stage D₂, reference numeral 715 denotes the (k+1)-th stage Dₖ₊₁, and reference numeral 720 denotes the last (n+1)-th stage D_{n+1,H}. The first to n-th stages have the same structure as each other, and their line gains correspond to matrix elements as seen from Equation (13).

The first stage 705 is configured by one basic block 705a, and its line gain values correspond to a matrix C_{n,0-2}_{ⁿ}. The second stage 710 is configured by two basic blocks 710a, and their line gain values correspond to C_{n-1,0-2}_{ⁿ⁻¹}. The (k+1)-th stage 715 is configured by 2^{k} basic blocks 715a, and line gains of the w-th basic block of the (k+1)-th stage 715 are shown in Equation (16).

$${\underline{C}}_{n - k , [ {2}^{n - k} \cdot {\sum }_{l = 1}^{k} bin ( w - 1 , l ) \cdot {2}^{k - l} ]} , w = 1 , … , {2}^{k} - 1 \qquad ( 16 )$$

It can be seen from FIG. 8 that a size of each basic block of a corresponding stage is small and the number of basic blocks is large, in the direction to the stage 720.

In other stages except the last stage, M inputs are summed two by two, and sum values are connected to M outputs. Inputs and outputs of the (n+1)-th stage 720 serving as the last stage are mapped in a one-to-one correspondence. As seen from Equation (13), the i-th input of the (n+1)-th stage 720 is mapped to the

$$j ( = {\sum }_{l = 1}^{n} bin ( i , l ) \cdot {2}^{n - l} ) \text{-} th$$

output, and a total line gain connected from the i-th input to the j-th output is

$${\frac{1}{\sqrt{M}} [ {\underline{Δ}}_{a} ]}_{ij} .$$

A gain of 1/\sqrt{M} is applied to the typical IFFT processor of the last stage, and other gains are gains to be additionally multiplied in accordance with an embodiment of the present invention.

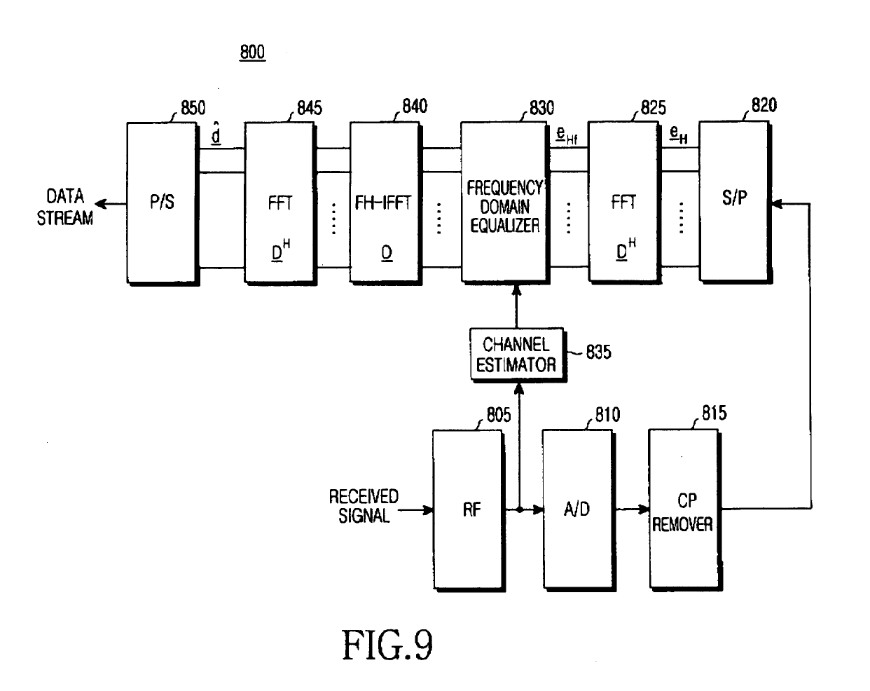

FIG. 9 is a block diagram illustrating a receiver 800 of the FFH/OFDM communication system in accordance with an embodiment of the present invention. Referring to FIG. 9, an RF unit 805 converts a multipath channel signal received through a receive antenna into a baseband signal. An A/D converter 810 converts the baseband signal into a digital signal. A CP remover 815 removes a CP from the digital signal, and outputs a signal e_{H} defined by Equation (17).
e_{H}=Hₜb_{H}+nₜ (17)

An S/P converter 820 converts the signal e_{H} in a parallel fashion, and inputs the converted signal to an FFT processor 825. The FFT processor 825 outputs a frequency domain signal e_{Hf}, which is defined in Equation (18).
e_{Hf}=D^{H}Hₜb_{H}+D^{H}nₜ=H_{f}D^{H}ΔₐDd+n_{f} (18)

In Equation (18), Hₜ and nₜ denote a channel matrix and a noise matrix based on time domain signal modeling in which a CP has not been considered. The frequency domain signal e_{Hf} is a signal with a phase has been changed according to the frequency and time domain transformations of a transmission signal vector. Accordingly, an estimated data vector \hat{d} is computed through an equalization process corresponding to the inverse matrix of a transformation matrix of the transmitter.

A frequency domain equalization process is implemented by a 1-tap equalizer 830 of the frequency domain (hereinafter, referred to as the frequency domain equalizer) using the inverse matrix of H^{f} associated with channel gains of subcarriers. That is, a channel estimator 835 estimates element values of the frequency domain channel matrix H_{f}, i.e., channel gain values of the subcarriers, using a signal received by the RF unit 805, and provides the frequency domain equalizer 830 with a result of the estimation. The frequency domain equalizer 830 multiplies the frequency domain signal e_{Hf} by the inverse matrix H_{f}^{H} of the channel matrix.

The output of the frequency domain equalizer 830 is input to an FH-IFFT processor 840 serving as a modified IFFT processor. Details of the FH-IFFT processor 840 are the same as those illustrated in FIG. 8. The diagonal element values of the matrix Δₐ^{H} are reflected in gain values of the last stage of the FH-IFFT processor 840. The diagonal element values of the matrix Δₐ^{H} to be multiplied in the last stage of the FH-IFFT processor 840 have a conjugate relation with the diagonal element values of the matrix Δₐ to be multiplied in the last stage of the FH-IFFT processor 410 of FIG. 4. Other gain values to be multiplied in the last stage of the FH-IFFT processor 840 are the same as those shown in Equation (7). In Equation (7), [f]ₗ is determined in advance between the transmitter and the receiver for frequency hopping.

The output of the FH-IFFT processor 840 is transferred to an FFT processor. The FFT processor 845 performs FFT by multiplying the output of the FH-IFFT processor 840 by an FFT matrix D^{H}. The output of the FTk processor 845 is an estimated data vector \hat{d} which is output as an estimated data stream through a P/S converter 850.

As is apparent from the above description, the present invention has a number of effects.

For example, the present invention maps each data element to the next subcarrier adjacent to a subcarrier of each previous data element in each sample time by using a cyclic frequency hopping pattern in a fast frequency hopping/orthogonal frequency division multiplexing (FFH/OFDM) communication system. When the cyclic frequency hopping pattern is used, a transformation matrix for FFH is a diagonal matrix. A gain of the last stage of an Inverse Fast Fourier Transform (IFFT) processor is only changed such that the FFH can be implemented. Accordingly, because a structure of a transmitter and receiver is simplified, a system whose hardware and computation complexity is low can be implemented.

Although preferred embodiments of the present invention have been disclosed for illustrative purposes, those skilled in the art will appreciate that various modifications, additions, and substitutions are possible, without departing from the scope of the present invention. Therefore, the present invention is not limited to the above-described embodiments, but is defined by the following claims, along with their full scope of equivalents.

1. A transmitter for performing fast frequency hopping (FFH) in an orthogonal frequency division multiplexing (OFDM) communication system using a plurality of subcarriers, comprising:
a serial-to-parallel (S/P) converter for converting an input data stream into a data vector having a plurality of data elements associated with subchannels;
a modified Inverse Fast Fourier Transform (IFFT) processor for transforming the data vector using IFFT, and outputting a transmission signal vector having a plurality of samples, which is formed by multiplying IFFT outputs of a last stage of the modified IFFT processor by predetermined gains according to a cyclic frequency hopping pattern, the cyclic frequency hopping pattern cyclically shifting subcarriers mapped to the subchannels in each sample time; and
a parallel-to-serial (P/S) converter for converting the transmission signal vector in a serial fashion and outputting a transmission signal.

2. The transmitter according to claim 1, wherein the cyclic frequency hopping pattern maps each data element of the data vector to a next subcarrier adjacent to a subcarrier mapped to each previous data element in each sample time.

3. The transmitter according to claim 2, wherein the cyclic frequency hopping pattern is expressed by a hopping pattern matrix including elements defined by:
[Ψ]_{l,m}=mod {([f]ₗ'm−1),M} for m=1, . . . , M, and
[Ψ]_{l,1}=[f]ₗ for l=1, . . . , M,
where [Ψ]_{l,m} denotes an element of an m-th column of an l-th row in the hopping pattern matrix, [f]ₗ denotes an index of a subcarrier mapped to a first data element, and M is the number of subcarriers, the element of the m-th column of the l-th row in the hopping pattern matrix indicating an index of a subcarrier mapped to an m-th data element in an l-th sample time.

4. The transmitter according to claim 1, wherein the predetermined gains are defined by:
$${[ {Δ}_{a} ]}_{l , m} = exp \{ j 2 π \frac{{[ f ]}_{l}}{M} ( l - 1 ) \} for l = m ,$$
where [Δₐ]_{l,m} denotes a gain to be multiplied by an l-th output of the last stage, and [f]ₗ denotes an index of a subcarrier mapped to a first data element in an l-th sample time.

5. The transmitter according to claim 1, wherein the modified IFFT processor comprises:
(log₂ M) stages having M inputs connected to the S/P converter and M outputs connected to a subsequent stage according to M subcarriers,
the (log₂ M) stages sum the M inputs two by two to couple sum values to the M outputs, and the last stage having the M inputs connected to the M outputs of a (log₂ M)-th stage of the (log₂ M) stages and the M outputs connected to the P/S converter, the last stage coupling an i-th input of the M inputs to a
$$j ( = {\sum }_{l = 1}^{n} bin ( i , l ) \cdot {2}^{n - l} ) \text{-} th$$
output of the M outputs, the bin(i,l) denoting an l-th digit of a binary value corresponding to a decimal value i.

6. The transmitter according to claim 5, wherein a total gain of a line connected from the i-th input to the j-th output in the last stage is defined by:
$$\frac{1}{\sqrt{M}} exp \{ j 2 π \frac{{[ f ]}_{i}}{M} ( i - 1 ) \} ,$$
where [f]ᵢ denotes an index of a subcarrier mapped to a first data element in an i-th sample time.

7. A receiver for recovering transmitted data according to a cyclic frequency hopping pattern in an orthogonal frequency division multiplexing (OFDM) communication system using a plurality of subcarriers, comprising:
a serial-to-parallel (S/P) converter for receiving, from a transmitter, a signal hopped to a frequency according to a cyclic frequency hopping pattern of a sample time unit, and converting the received signal into a first received signal vector having a plurality of data samples, the cyclic frequency hopping pattern cyclically shifting subcarriers mapped to subchannels in each sample time;
a first Fast Fourier Transform (FFT) processor for transforming the first received signal vector into a second received signal vector of a frequency domain using FFT;
an equalizer for multiplying the received signal vector by an inverse matrix of a channel matrix representing characteristics of a channel from the transmitter to the receiver;
a modified Inverse Fast Fourier Transform (IFFT) processor for transforming an output of the equalizer using IFFT, and multiplying IFFT outputs of a last stage of the modified IFFT processor by predetermined gains associated with the cyclic frequency hopping pattern of the transmitter;
a second FFT processor for transforming output of the modified IFFT processor using FFT to output a recovered received signal vector; and
a parallel-to-serial (P/S) converter for converting the recovered received signal vector in a serial fashion and outputting a data stream.

8. The receiver according to claim 7, wherein the cyclic frequency hopping pattern maps each data element of the data vector to a next subcarrier adjacent to a subcarrier mapped to each previous data element in each sample time.

9. The receiver according to claim 8, wherein the cyclic frequency hopping pattern is expressed by a hopping pattern matrix including elements defined by:
[Ψ]_{l,m}=mod {([f]ₗ+m−1), M} for m=1, . . . , M, and
[Ψ]_{l,1}=[f]ₗ for l=1, . . . , M,
where [Ψ]_{l,m} denotes an element of an m-th column of an l-th row in the hopping pattern matrix, [f]ₗ denotes an index of a subcarrier mapped to a first data element, and M is a number of subcarriers, the element of the m-th column of the l-th row in the hopping pattern matrix indicating an index of a subcarrier mapped to an m-th data element in an l-th sample time.

10. The receiver according to claim 7, wherein the predetermined gains are defined by:
$${[ {Δ}_{a} ]}_{l , m} = exp \{ j 2 π \frac{{[ f ]}_{l}}{M} ( l - 1 ) \} for l = m ,$$
where [Δₐ]_{l,m} denotes a gain to be multiplied by an l-th output of the last stage, and [f]ₗ denotes an index of a subcarrier mapped to a first data element in an l-th sample time.

11. The receiver according to claim 7, wherein the modified IFFT processor comprises:
(log₂ M) stages having M inputs connected to the equalizer and M outputs connected to a subsequent stage according to M subcarriers,
the (log₂ M) stages summing the M inputs two by two to couple sum values to the M outputs; and
the last stage having the M inputs connected to the M outputs of a (log₂ M)-th stage of the (log₂ M) stages and the M outputs connected to the second FFT processor, the last stage coupling an i-th input of the M inputs to a
$$j ( = {\sum }_{l = 1}^{n} bin ( i , l ) \cdot {2}^{n - l} ) \text{-} th$$
output of the M outputs, the bin(i,l) denoting an l-th digit of a binary value corresponding to a decimal value i.

12. The receiver according to claim 11, wherein a total gain of a line connected from the i-th input to the j-th output in the last stage is defined by:
$${\frac{1}{\sqrt{M}} [ {\underline{Δ}}_{a} ]}_{l , m} , {and [ {Δ}_{a} ]}_{l , m} = exp \{ j 2 π \frac{{[ f ]}_{l}}{M} ( l - 1 ) \} for l = m ,$$
where [Δₐ]_{l,m} denotes a gain to be multiplied by an l-th output of the last stage, and [f]ₗ denotes an index of a subcarrier mapped to a first data element in an l-th sample time.
